(19) United States
(12) Patent Application Publication
(10) Pub. No.: US 2007/0287374 A1
(43) Pub. Date: Dec. 13, 2007

(54) Novel Fresh Venting Systems and Methods for Passenger Vehicles

(76) Inventors: Timothy Day, Huntington Beach, CA (US); Kathy Hermreck, Anaheim, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 11/467,542

(22) Filed: Aug. 26, 2006

Related U.S. Application Data
(60) Provisional application No. 60/811,733, filed on Jun. 8, 2006.

(51) Int. Cl. B60H 1/34; B60H 3/06

(52) U.S. Cl. 454/158; 454/155

(57) ABSTRACT

Improved systems and methods allow users to filter air by installing an apparatus between the passenger space and the air circulating in from the outside of a vehicle, proximate to existing vents, or as a mechanically elegant improvement to new systems. A hinge mechanism allows a venting system to open reliably, and a filter element discretely cleans air passing through it.

### CROSS REFERENCE TO RELATED APPLICATIONS

The instant disclosure claims the priority benefit of U.S. Provisional Patent Application Ser. No. 60/811,733. entitled FRESH VENT™ filed Jun. 18, 2006, full Paris Convention Priority is hereby expressly reserved.

### BACKGROUND OF THE DISCLOSURE

1. Field of the Disclosure

This disclosure relates to systems for providing cleaner air to users, among other things. In particular, the disclosure relates to a system to ensure cleaner air inside of the passenger compartment of vehicles by using a filter between the venting mechanism and the rest of the vehicle, without serious mechanical challenge to the system, such that it could function complementary to existing systems.

2. General Background of the Art

Many attempts have been made to improve the quality of life of daily commuters. For example, in California, and in other places, commuters literally are inside of their cars for thousands of hours per year. Although Americans spend millions of dollars annually making sure their homes have clean filtered air, commuters are subjected to a steady stream of polluted air blowing directly into their faces while inside their cars. For many, the daily commute entails slow moving freeway travel which has concentrated amounts of carbon monoxide and other harmful emissions.

Prior attempts to understand and address this issue have not presented solutions which could actually be implemented, or function in conjunction with existing technology. For this reason, among others, solving the instant issues requires not merely describing or understanding them, but crafting way around them that can be practiced.

As well known to those skilled in the art, most automobiles are typically provided with air conditioning apparatuses, such as heaters or air conditioners, for discharging impure air from the passenger compartment to the atmosphere and feeding fresh hot or cool air into the compartment. Such fresh air fed from such an air conditioning apparatus is blown into the passenger compartment through the grillwork of a vent assembly installed at a dashboard.

The grillwork of a conventional vent assembly, acting as the final path guiding the fresh hot or cool air into the passenger compartment, comprises a plurality of grating bars which have a blade shape and are movably set in a grill frame fixedly installed in the venting channel of a dashboard. Therefore, when it is desired to change the air blowing direction of the grillwork, the grating bars are manually tilted upward, downward, leftward or rightward at a limited angle within the fixed grill frame.

Most significantly, air quality issues have deleteriously impacted the passenger breathing space of cars in major metropolitan regions. For example, the greater Los Angeles area has longstanding needs in terms of air quality, addressed and overcome by the teachings of the present disclosure. Those with special breathing needs are likewise negatively impacted and shall benefit from readily replaceable and exchangeable filters in their cars.

Generally speaking, in such a conventional vent assembly for automobiles, the air blowing direction of the grillwork is limitedly controlled by manually tilting the blade-shaped grating bars in the fixed grill frame to a desired direction within a limited angular range. It is thus almost impossible to clean the interior of the venting channel in back of the grill frame, and so a great quantity of dust is deposited in the venting channel as time goes by after the production of an automobile. Such deposited dust is blown into the passenger compartment along with fresh hot or cool air during an operation of an air conditioning apparatus, such as a heater or an air conditioner, thus being bad for passengers' health, particularly, for passengers' respiratory organs, and causing several diseases in said organs. Furthermore, the conventional vent assembly does not allow an installation of an air filter at a position around it, and so most passengers, including a driver while driving an automobile, inevitably breathe dust-laden air blown from the grillwork.

It is respectfully submitted that the teachings of the present disclosure solve the longstanding need to provide a way to filter the air coming into the passenger spaces of vehicles, whether during original manufacture of the vehicles or otherwise by retro-fitting systems that exist in current cars. Since this has not been accomplished to date, a longstanding need remains to be addressed. The present disclosure addresses and ameliorates this longstanding need.

### SUMMARY OF THE DISCLOSURE

Briefly stated, improved systems and methods allow users to filter air by installing an apparatus between the passenger space and the air circulating in from the outside of a vehicle, proximate to existing vents, or as a mechanically elegant improvement to new systems. A hinge mechanism allows a venting system to open reliably, and a filter element discretely cleans air passing through it.

According to a feature of the present disclosure there is provided an apparatus for filtering air in a vehicle, comprising, in combination, a hinge mechanism for connecting a front panel having an inside and an outside surface of a conventional vent assembly the remainder of the assembly, a clip set to operatively position a filter member, and a filter member sited to sized to substantially cover an inside surface of the front panel.

According to another feature of the present disclosure there is provided, An apparatus for filtering air in a vehicle, comprising, in combination, a hinge mechanism for connecting a front panel, having an inside and an outside surface, of a conventional vent assembly to the remainder of the assembly;

at least a clip, disposed along an inside surface of the panel, to operatively position a filter member, and a filter member sized to substantially cover an inside surface of the front panel. According to another feature of the present disclosure there is provided a process for enhancing air quality in a passenger vehicle, comprising in combination: providing a kit including a hinge and clip assembly and a universally adjustable air filter member effective to function in a conventional vent assembly

According to a feature of the present disclosure there is provided a process for enhancing air quality in a passenger vehicle, comprising in combination, providing a kit including a hinge and clip assembly and a universally adjustable air filter member effective to function in a conventional vent assembly, providing instructions for installing the kit within the vehicle.

According to a feature of the present disclosure there is provided a process for assembling a fresh venting improved system comprising, in combination, modifying a venting mechanism having a slotted panel to render it hinged, having a slotted panel adding clips to a back side of the venting mechanism, to have a filter member.

### BRIEF DESCRIPTION OF THE DRAWINGS

The above-mentioned features and objects of the present disclosure will become more apparent with reference to the following description taken in conjunction with the accompanying drawings wherein like reference numerals denote like elements and in which:

FIG. 1 is a schematic depiction of a conventional motor vehicle internal cockpit and dashboard and center assembly arrangement, showing one location effective for use with the present disclosure;

FIG. 2 is a schematic drawing showing an embodiment of the present disclosure from a first, or external view;

FIG. 3 is a schematic drawing showing an embodiment of the present disclosure from a second, or internal view, in partially exploded fashion; and;

FIG. 4 likewise illustrates a schematic of an assembled embodiment of the present disclosure from a side view.

### DETAILED DESCRIPTION

The present inventor has discovered that he can solve a longstanding need by implementing an elegant, mechanically straightforward solution to a problem that has not been effectively addressed among the teachings of the prior art. The Fresh Vent™ is a universal and revolutionary air cleaning system effective for use with virtually every type of automobile. The purpose of the invention is to ensure cleaner air inside the passenger compartment of vehicles, air quality integrity is essential for many breathing challenged individuals, as well as a luxury item that consumers wish to have, which is not currently available. The present disclosure changes this.

The manner of cleaning the air is to insert a high quality air filter cartridge into, for example, an automobile's existing air vents. As the outside air is forced through the vents, it passes through the Fresh Vent™ system before it is passed onto automobile drivers and passengers. It is mechanically simple enough either to be placed into production, or enabled for retrofitting, as discussed and claimed below.

By way of example, all automobiles have air vents. The same vents that are used for heating and air conditioning allow dirty polluted air from the outside to enter the interior of the car. According to the teachings of the Fresh Vent™ system, the instant disclosure is designed to clean the air as it flows into the passenger compartment.

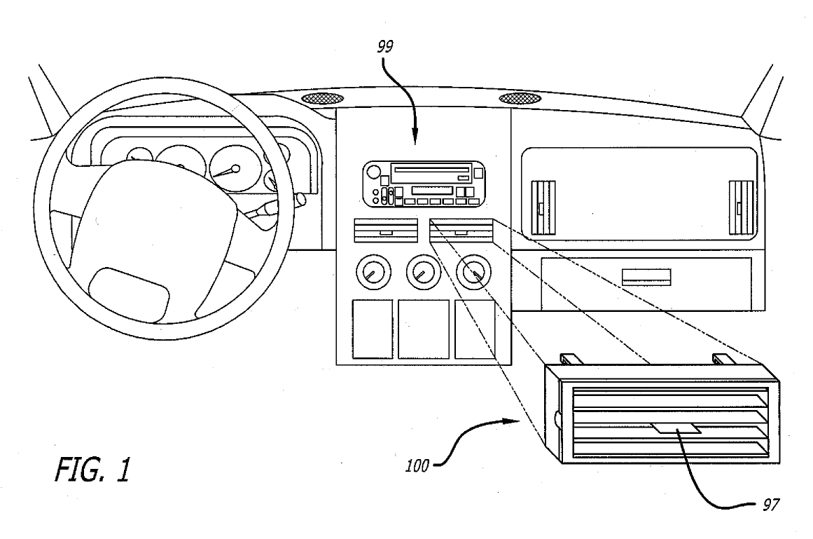

Referring now to FIG. 1, venting mechanism 100 is housed in any conventional vehicle dashboard and central assembly 99, and often is placed in several locations, which drivers can generally reach and move by transferring tabbed arm 97 from a first to a second position, to govern the flow of air through venting mechanism 100.

Referring now also to FIG, 2, venting mechanism is comprised of panel 101 which is located in front of, and partially conceals filter element 222, which is inserted along the line designated 4 behind front panel 101, where it fits and covers the space through which air travels into the passenger compartment of any conventional vehicle. Hinge 103 allows panel 101 to move from an open to a closed position. Finger pull 107 is moved from a first to a second position, to release front panel 101.

FIG. 3 likewise illustrates the reverse side of panel 101, with clipping members 38 positioned to receive filter element 222. Filter element 222 thus may be readily accessed, changed and replaced, by sliding it between opposing clips 38, as shown in the figure.

According to teachings of the present disclosure a fresh venting system kit in an embodiment has at least two steps: (1) first, the car is modified by adding a simple hinge to the vent so that it opens easily, and clips are added to the back side for the filter to slide into; and (2) second, a quality air filter built to size, is inserted. The vent is then closed and the filter is discretely cleaning the air, while remaining out of sight.

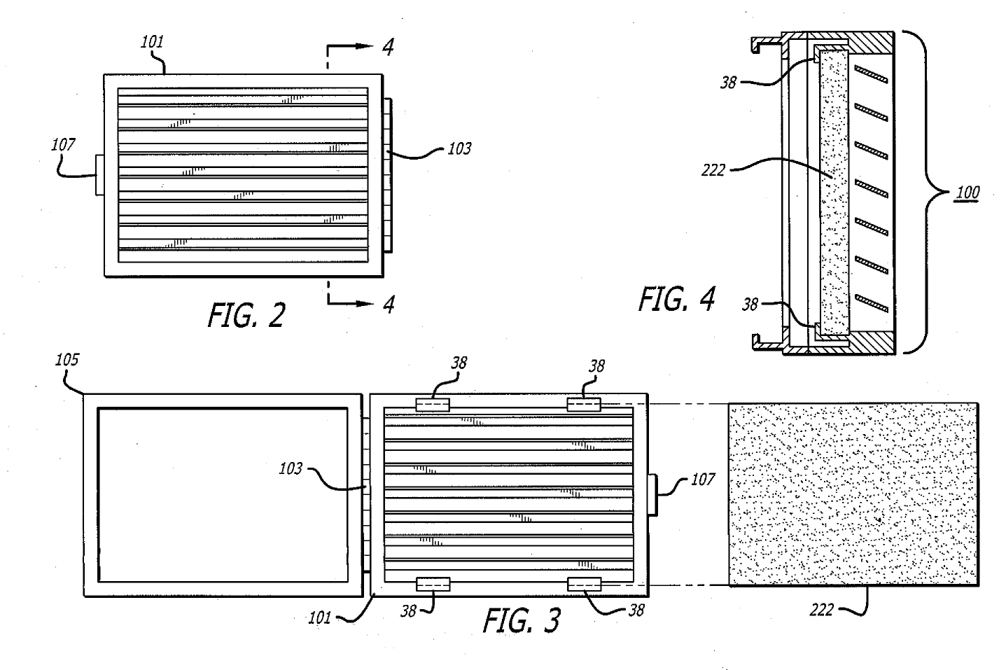

The existing automobile vents are altered from their existing design to include a hinge on one side and clips on the back side for the filter to slide into. The hinge is placed on one side of the vent to allow the same to open easily. (See FIG. 2) A finger pull is opposite the hinge side to allow easy access. (See FIG. 3) Clips, or simple “L” shaped pieces of vent material (usually plastic or metal) are added to the back side of the vents to allow the fiber to slide in and prevent the filter from becoming dislocated. (See FIG. 4)

The filter is an important aspect of the ease of use of the instant teachings.

According to an embodiment, a high efficiency particulate air filter, which is a product already on the market, is stretched between plastic or cardboard rails, so it is framed. The filter material will remove particulate matter four microns in size or larger. Stretching the filter material between rails, or framing it, ensures the filter product remains taught during driving, while air is forced through. The rails prevent the filter material from slipping, or bunching up, which would permit unfiltered air to pass through gaps. This undesirable result is prevented by inserting the filter between rails.

Turning now to FIG. 4, an internal view demonstrates filter element 222, housed within clip set 38 in venting mechanism 100. The instant system can be implemented in any known vehicles simply and/or installed in newly created vehicles.

The height and width of the filters vary in size, to accommodate different vehicle vent sizes. The thickness of the filter is thin, so as to allow maximum air flow speed when the air conditioner and heater are running, could be, for example 1/32nd to ⅛th of an inch thick, and shown in the illustrative embodiment features

Those skilled in the automotive arts will readily understand that a variety of products which are needed for every-day service of vehicles and routine at-home: maintenance are useful with the present disclosure.

Turning now to the figures again, altering the vent may be done either by a consumer, an auto repair service provider or a dealer. By offering a do-it-yourself type of kit the instant teachings are differentiated from the art. Likewise, by being easy to install, it works with known systems.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. An apparatus for filtering air in a vehicle, comprising, in combination:
a hinge mechanism for connecting a front panel, having an inside and an outside surface, of a conventional vent assembly to the remainder of the assembly;
at least a clip, disposed along an inside surface of the panel, to operatively position a filter member, and a filter member sized to substantially cover an inside surface of the front panel.

2. The apparatus of claim 1, further comprising a plurality of clips.

3. The apparatus of claim 1, further comprising at least two sets of opposing clips, arranged generally parallel at opposing locations along the inside surface of the panel.

4. A process for enhancing air quality in a passenger vehicle, comprising in combination:
providing a kit including a hinge and clip assembly and a universally adjustable air filter member effective to function in a conventional vent assembly; and
providing instructions for installing the kit within the vehicle.

5. A process for assembling a fresh venting improved system comprising, in combination:
modifying a venting mechanism, having a slotted panel, to render it hinged;
adding clips to a back side of the venting mechanism; for housing a filter member;

6. The process of claim 5, further comprising the step of emplacing the finished unit in a vehicle.

7. The process of claim 5, further comprising a vehicle with at least one of an existing vent and a set of vents.

8. Process of claim 5 further comprising a vehicle custom fitted for use fresh venting with a filter.
